(19) United States
(12) Patent Application Publication
(10) Pub. No.: US 2021/0261395 A1
(43) Pub. Date: Aug. 26, 2021

(54) Low Profile Adjustable Height Operator Platform

(71) Applicant: John Stephen LANPHEAR, Lawrence, MI (US)

(72) Inventor: John Stephen LANPHEAR, Lawrence, MI (US)

(21) Appl. No.: 17/178,702

(22) Filed: Feb. 18, 2021

Related U.S. Application Data
(60) Provisional application No. 62/979,183, filed on Feb. 20, 2020.

(51) Int. Cl. B66F 11/04

(52) U.S. Cl. CPC B66F 11/04

(57) ABSTRACT

A low-profile adjustable height operator platform includes a low-profile frame, which includes a plurality of struts, and one or more kick plates. The one or more kick plates flank the perimeter of the low-profile frame, acting to structurally support the low-profile so that the platform can achieve a low profile without sacrificing its holding capacity. The low profile of the platform (e.g., being as low as two inches from the ground surface) enables the platform to accommodate and support operators of a variety of heights.

### CROSS-REFERENCE TO RELATED APPLICATIONS

This application claims benefit of U.S. Provisional Patent Application No. 62/979,183, which was filed on Feb. 20, 2020 and titled “Low Profile Adjustable Height Operator Platform”. The entire content of this application is incorporated herein by reference.

### BACKGROUND OF THE INVENTION

The present invention pertains to operator platforms and, more particularly, to height-adjustable operator platforms.

Operators/workers are often inconvenienced by conveyors, machinery, or other work that cannot be easily adjusted in height. In such cases, operators often need to reach or position themselves in ways that are uncomfortable for themselves and inefficient for the operation. As a result, operator platforms that raise and lower operators as needed relative to the machinery or other work have been developed to optimize the comfort of the operators and the ergonomics of the operation. The height at which a platform is optimally positioned depends upon the height of the operator using the platform. An operator platform that supports operators of a variety of heights so as to accommodate a physically diverse workforce is desirable.

### SUMMARY OF THE INVENTION

The present invention is directed to a low-profile adjustable height operator platform that can raise and lower an operator in order for the operator to perform work, such as at a machine or a conveyor, while doing so using good ergonomics for the body size of the operator. The platform includes a low-profile frame and one or more kick plates, also referred to as kick guard panels. The low-profile frame includes a first plurality of struts arranged to establish a perimeter of the low-profile frame and a second plurality of struts arranged to establish a strut pattern that is interior to the perimeter of the low-profile frame. The perimeter of the low-profile frame has an exterior surface. The one or more kick plates are attached to the exterior surface of the perimeter of the low-profile frame and extend above the low-profile frame, acting to structurally support the low-profile so that the platform can achieve a low profile without sacrificing its holding capacity. The platform travels vertically, while going as low as 2″ above a floor. This height is achieved by integrating the low-profile frame with the kick plates that act as a frame structural support. This kick plate preferably runs the entire length of the platform on preferably at least two sides lengthwise.

In one embodiment of the invention, the low-profile frame is rectangular and positioned beneath one or more floor plates which support an operator using the platform. Kick plates run alongside the exterior of at least two sides of the rectangular frame and extend perpendicular to and above the one or more floor plates. A guard rail helps prevent operators from falling off the platform and also runs alongside and perpendicular to the exterior surface of the frame. Linear actuator systems attached to the low-profile frame help raise and lower the low-profile frame and floor plates as needed to comfortably position the operator. Lifting the platform is preferably at least four linear actuators, preferably one near each corner. For larger platform lengths and widths, more lifting linear actuators could be used in-between the others. In one case, as an example, the platform is preferably 172″ long by 48″ wide, and has two lifting linear actuators, preferably electric screw drive actuators, on one long side in each corner, and three linear actuators along the other side with one actuator in each corner and one actuator in-between those two actuators. The frame of this platform is preferably made using 1″×1″ welded tube steel, and is designed in such a pattern that optimizes the strength of the frame when connected to each of these lifting linear actuators. One or more sensors are placed on the underside of the low-profile frame to help prevent an operator or other object from being crushed underneath the frame as it is lowered from a raised position.

In another embodiment of the invention, the platform includes additional safety features in the form of guard panels and/or certified safety mats. Guard panels are mounted to the ground or to non-moving parts of the platform and alongside the platform to prevent objects from moving underneath the low-profile frame as it is raised and lowered. There preferably is a guard panel on at least one side connected to the floor or to the bottom non-moving part of the lifting linear actuators, to help to prevent pinch points. A guard railing could preferably be utilized on at least one side, and at least one side is left open to allow the operators to walk up on the platform and down from the platform. Preferably the open side would be fully open in-between the lifting linear actuators so as to allow the operator to have un-obstructed access to the machine or work to be done in front of them. This platform would preferably utilize a type of ergonomic cushioned mat in order to promote good health to operators standing for longer periods of time.

To help prevent pinch points at the sides from the floor to the moving platform, a certified safety mat is positioned preferably at each moving edge of the platform where an operator is not protected by the guard panels. This safety mat electrically ties into the lifting platform's controller to prevent any vertical adjustment while a person was standing on the safety mat. Certified safety mats are pressure-sensitive mats positioned at moving edges of the platform. When pressure is applied to a certified safety mat, movement of the low-profile frame is halted or prevented until the pressure is removed. This platform also can include a ramp to walk or wheel up onto the platform.

Additional objects, features and advantages of the invention will become more readily apparent from the following detailed description of preferred embodiments thereof when taken in conjunction with the drawings wherein like reference numerals refer to common parts in the several views.

### BRIEF DESCRIPTION OF THE DRAWINGS

FIG. 1 is a rear perspective view of an operator platform in accordance with a first embodiment of the present invention that is in a lowered position;

FIG. 2 is a rear perspective view of the operator platform of FIG. 1 in a raised position;

FIG. 3 is a top perspective view of the operator platform of FIG. 1 with its floor plates removed;

FIG. 4 is a close-up view of the main frame of the operator platform shown in FIG. 3;

FIG. 5 is a partial left perspective view of the operator platform of FIG. 1;

FIG. 6 is a rear perspective view of an operator platform in accordance with a second embodiment of the present invention in a lowered position;

FIG. 7 is a front perspective view of the operator platform of FIG. 6;

FIG. 8 is a rear perspective view of the operator platform of FIG. 6 in a raised position;

FIG. 9 is a front perspective view of the operator platform of FIG. 8;

FIG. 10 is a rear perspective view of an operator platform in accordance with a third embodiment of the present invention in a lowered position; and

FIG. 11 is a rear perspective view of the operator platform of FIG. 10 in a raised position.

### DETAILED DESCRIPTION OF THE PREFERRED EMBODIMENTS

Detailed embodiments of the present invention are disclosed herein. However, it is to be understood that the disclosed embodiments are merely exemplary of the invention that may be embodied in various and alternative forms. The figures are not necessarily to scale, and some features may be exaggerated or minimized to show details of particular components. Therefore, specific structural and functional details disclosed herein are not to be interpreted as limiting, but merely as a representative basis for teaching one skilled in the art to employ the present invention.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

In addition, any specific numerical value listed includes a margin of error of +/−5%. Accordingly, a length of 100 cm includes lengths between 95 and 105 cm. Similarly, the terms “horizontal”, “vertical”, “parallel” and “perpendicular” are defined as including a margin of error of 5° such that an object need not be perfectly horizontal, for example. The term “approximately” increases these various margins to 10% and 10°.

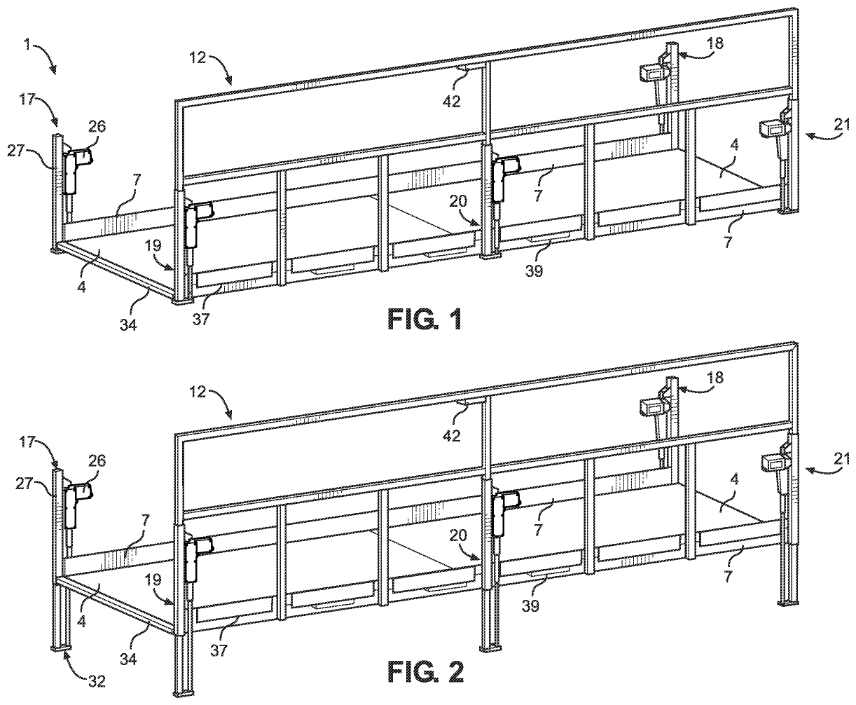

With initial reference to FIGS. 1 and 2, there is shown a low-profile height adjustable operator platform 1 in accordance with a first embodiment of the present invention. As shown, platform 1 includes two horizontal and rectangular floor plates 4 which support one or more operators/workers. However, the shape and number of the floor plates that can be used in connection with the present invention are not limited to being rectangular and two, respectively. For example, depending upon the desired size of the low-profile platform, the platform can include one floor plate or can include three or more floor plates and the floor plates can have a square shape. Preferably, the floor plates are steel plates. Also preferably, one or more ergonomic cushioned mats (not shown) are utilized upon one or more floor plates 4 in order to promote the wellbeing of operators using platform 1 for long periods of time. Although not shown, platform 1 could include one or more ramps that facilitate an operator's ascension to floor plates 4 from the ground surface.

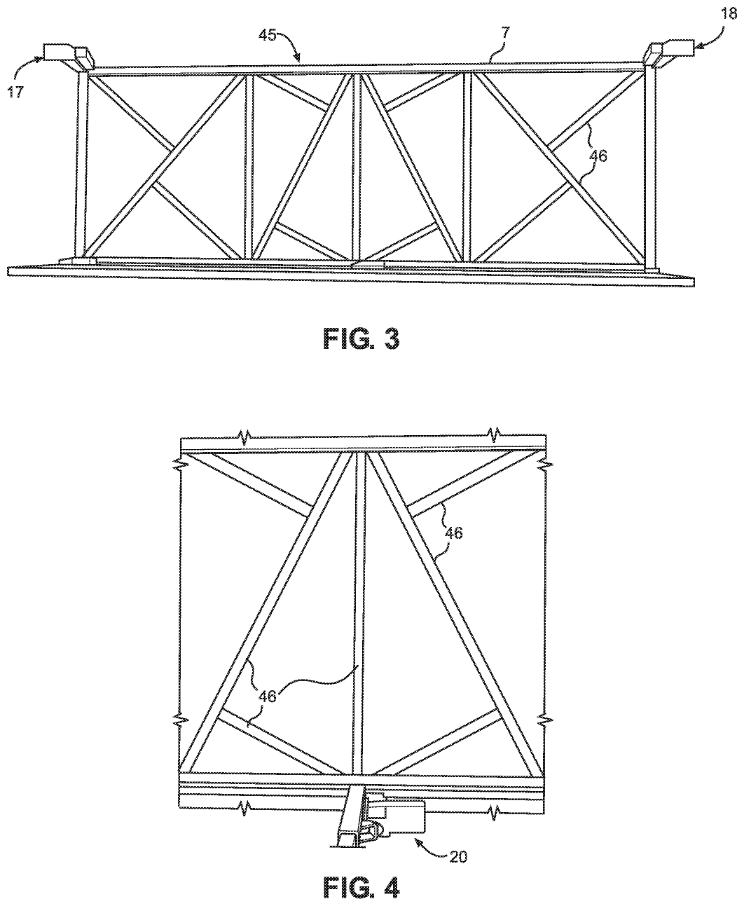

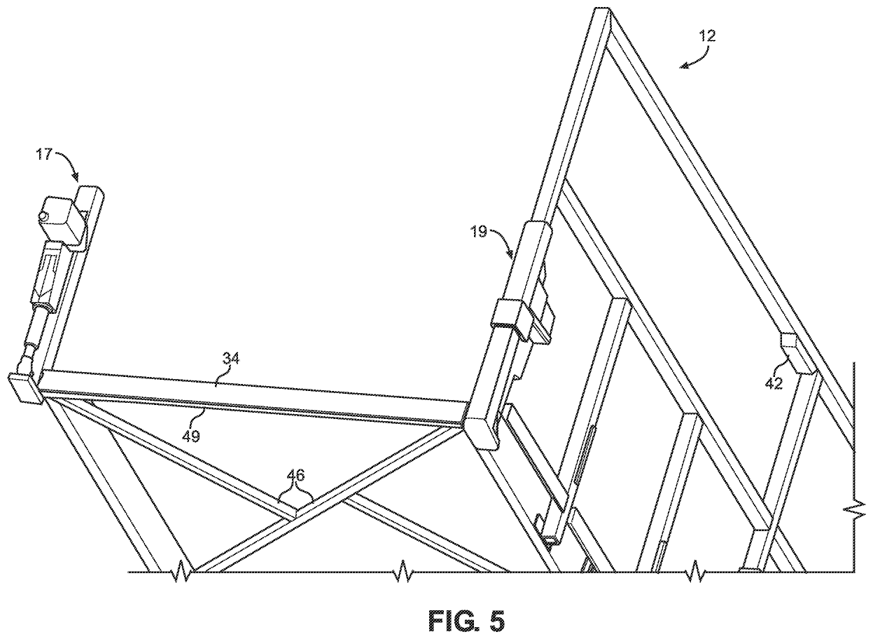

Floor plates 4 are supported underneath by a main frame 45 which is best seen in FIGS. 3 and 4 (main frame 45 is not seen in FIG. 1 or 2 because main frame 45 is covered by floor plates 4, which are not present in FIGS. 3 and 4). Main frame 45 has a plurality of struts 46 which vary in length. Four of the struts 46 are arranged to provide a rectangular perimeter having an exterior surface. Interior to the rectangular perimeter, fifteen additional struts 46 are arranged in a pattern that preferably optimizes the strength of main frame 45. As shown in FIGS. 3 and 4, the pattern of struts 46 is a symmetrical pattern in which struts 46 outline numerous triangle shapes. However, a main frame for a platform in accordance with the present invention is not limited to the perimeter shape, strut pattern, or number of struts exemplified in FIGS. 3 and 4. Preferably, struts 46 are made of one inch by one inch welded tube steel. One or more kick plates 7 are attached to and run alongside the exterior surface of the rectangular perimeter of frame 45. Kick plates 7 are parallel to the exterior surface of the rectangular frame and perpendicular to floor plates 4, preferably extending from the bottom of main frame 45 to a few inches (e.g., 1-4 inches) above floor plates 4. Preferably, kick plates 7 run along a substantial majority of the length of frame 45 (e.g., along the entire length except where an actuator system may be attached as described below) on at least two sides thereof and act to structurally support main frame 45 so that platform 1 can achieve a low profile without sacrificing its holding capacity. For example, while floor plates 4 can be as low as two inches from the ground surface, platform 1 can have a lift capacity between approximately 1,100 lbs. and 4,000 lbs. In effect, the pattern of struts 46 and the kick plate 7 being integrated with and extending above frame 45, work together to strengthen main frame 45.

A guard rail 12 also runs alongside and perpendicular to the exterior surface of frame 45. Guard rail 12 helps prevent operators from falling off platform 1. Preferably, guard rail 12 runs the entire length of one exterior side of frame 45. However, more than one guard rail can be employed, being provided on additional sides of frame 45. Ideally though, platform 1 has at least one side that lacks a guard rail so as to provide operators with unobstructed access to the machine or other work.

Main frame 45, topped by floor plates 4 and flanked by one or more kick plates 7, travels vertically to raise or lower operators as needed. Preferably, floor plates 4 are positioned as low as two inches, and as high as 14 inches, above the ground surface so as to accommodate operators having a range of heights. However, the platform of the present invention is not limited to this range of motion. Preferably, main frame 45 is raised and lowered using linear electric screw actuators. Ideally, at least four actuators are used, one near each corner of the platform. For platforms of greater lengths and/or widths (e.g., 172 inches long and 48 inches wide), more actuators could be used. For example, five actuators could be employed: one near each of four corners of the platform and an additional actuator along one of the long sides of the platform between two of the corner actuators. In the embodiment of FIGS. 1 and 2, pillars (or actuator systems) 17-21, each having a linear electric screw actuator, are employed to raise and lower floor plates 4. Each of pillars 17-21 is connected to main frame 45. Representative pillar 17 includes a linear electric screw actuator 26 mounted upon a rail 27 (e.g., using a gusset mount). As best seen in FIG. 2 which shows platform 1 in a raised position, rail 27 slides along a lower leg assembly 32 having a foot plate (not separately labeled) that is in contact with the ground surface. Actuator 26 includes a housing (not separately labeled, preferably made of a high-strength plastic) that protects a motor (e.g., a DC magnet motor) and gears within (not shown). Actuator 26 further includes a piston rod (not separately labeled) connected to the foot plate of lower leg assembly 32. In use, the motor of actuator 26 moves its respective piston rod into or out of its respective housing. As the piston rod is moved out of its housing, rail 27 slides upwardly along lower leg assembly 32 to vertically raise main frame 45. Each of the other pillars, pillars 18-21, although not separately labeled, similarly include: a linear electric screw actuator having a housing, a motor, gears and a piston rod; a rail; and a lower leg assembly with a foot plate. In use, piston rods of electric actuators 26 move synchronously to uniformly raise and lower main frame 45 (i.e., main frame 45 and floor plates 4 stay horizontally oriented while being moved in the vertical direction). Actuator systems for use with the platform of the present invention are not limited to the systems disclosed in FIGS. 1 and 2. For example, platform 1 could alternatively employ a linear actuator system in which a linear actuator is directly attached to main frame 45.

Exterior surfaces of main frame 45 that are not flanked by one or more kick plates 7 are preferably covered by deck end covers. In FIGS. 1 and 2, a representative deck end cover 34 preferably extends the width of frame 45, between pillars 17 and 19. Another deck end cover preferably extends the width of the frame 45 between pillars 18 and 21.

FIGS. 1 and 2 further show one or more electrical covers 37 and one or more controllers 39 that are preferably positioned on surfaces of one or more kick plates 7 opposite main frame 45 and between pillars 19 and 20, and pillars 20 and 21. One or more controllers 39 are electrically connected to pillars 17-21 and to a hand switch 42 located on guard rail 12. An operator utilizes one or more buttons present on hand switch 42 to send instructions to one or more controllers 39 to raise or lower main frame 45.

FIG. 5 shows a partial underside view of platform 1 with floor plates 4 removed. On the underside of one or more struts 46 (preferably struts 46 that make up the rectangular perimeter of main frame 45) there is preferably located one or more pressure-sensitive sensors 49. Sensor 49 is a pressure-sensitive strip that helps protect operators or other objects from being crushed underneath main frame 45 as it moves from a raised position to a lowered position. As main frame 45 is lowered from a raised position, if an object touches sensor 49, the lowering motion is halted and main frame 45 is retracted upwards. One or more sensors 49 are preferably electrically connected to the one or more controllers 39. As shown, sensor 49 is located on a strut 46 that is at least partially covered by deck end cover 34. However, sensor 49 could be located on alternative or additional struts 46 of main frame 45 as needed. A platform in accordance with the present invention could additionally or alternatively use other types of sensors (e.g., optical sensors) to promote safety during the raising and lowering operations.

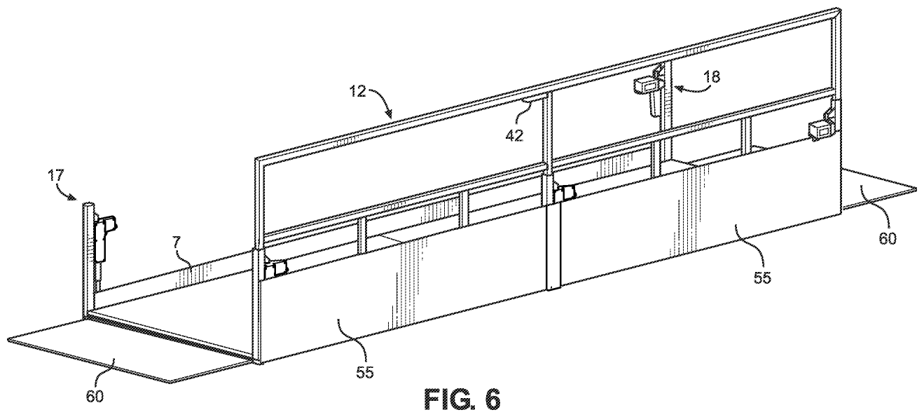

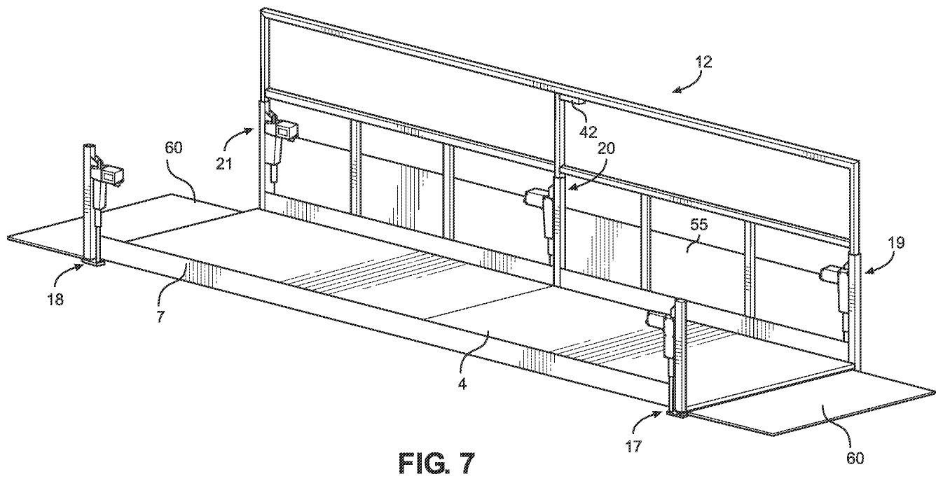

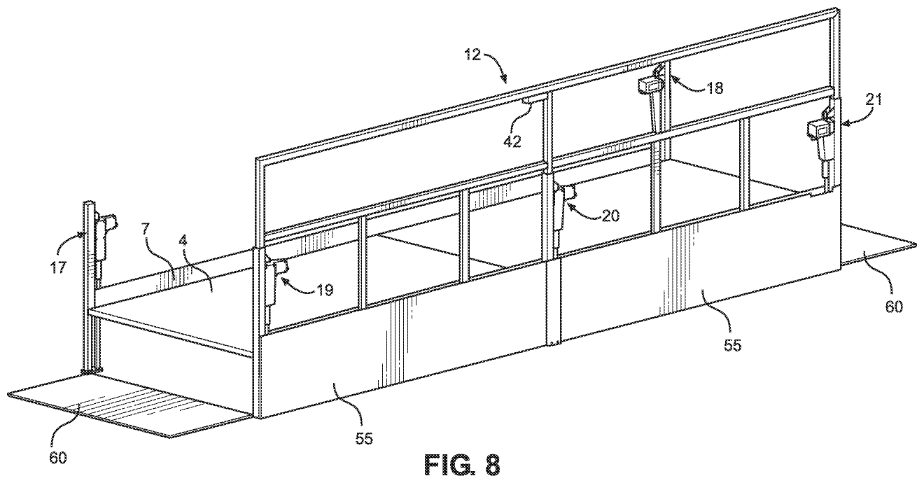

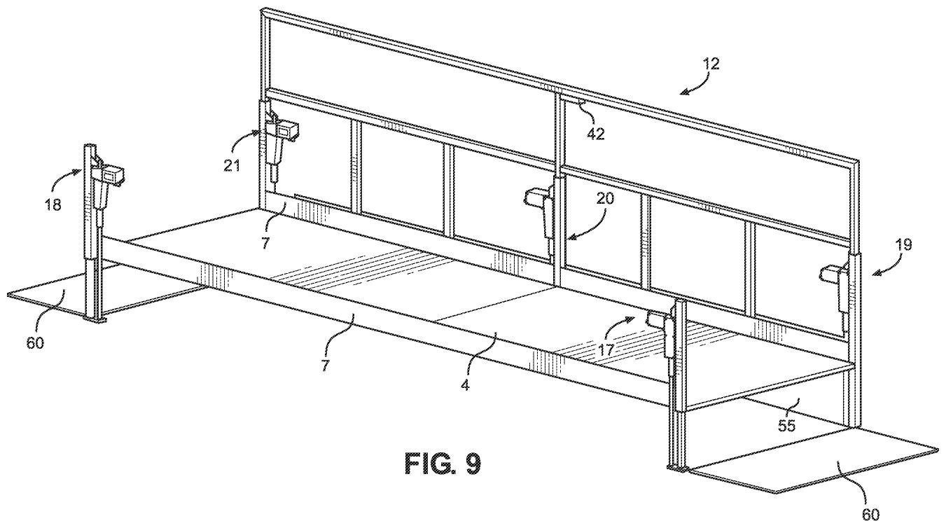

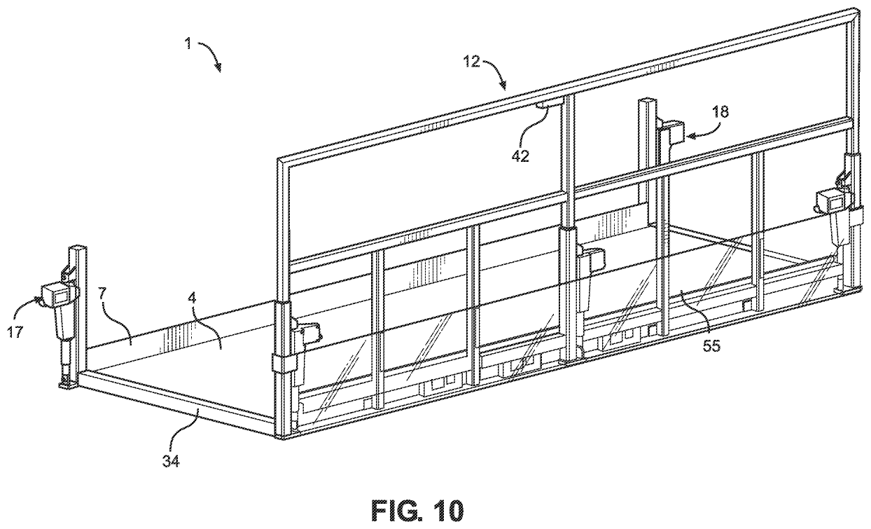

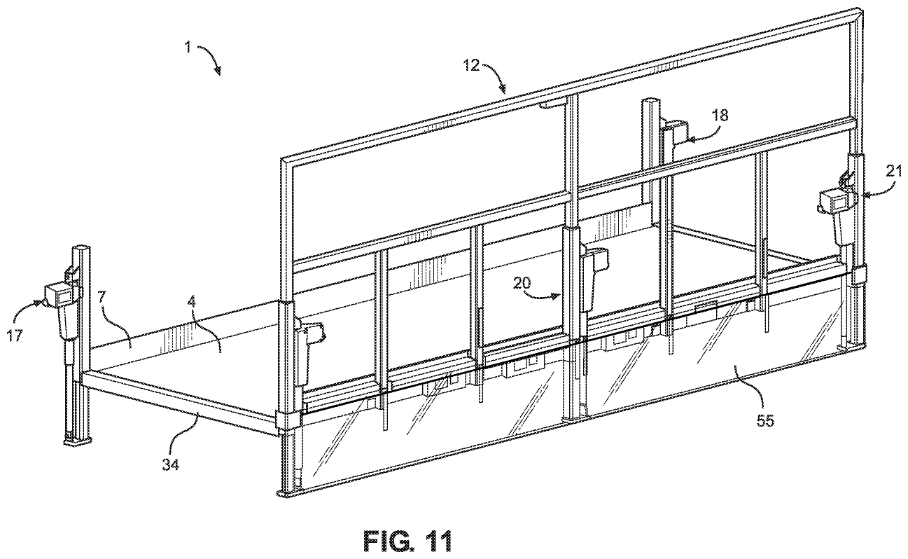

As shown in FIGS. 6-9, additional safety features in the form of one or more guard panels 55 and one or more certified safety mats 60 can also be utilized with a platform of the present invention. Guard panels 55 are preferably mounted on at least one side of the platform (e.g., the side of the platform having guard railing 12) and to either the ground surface or to non-moving parts of pillars 17-21 (e.g., foot plates). Guard panels 55 run perpendicular to floor plates 4 and the exterior perimeter surface of main frame 45 and help to prevent pinch points between main frame 45 and the ground surface as main frame 45 is lowered and raised. FIGS. 6-9 show guard panels 55 being opaque. In an alternate embodiment shown in FIGS. 10 and 11, guard panels 55 can be transparent. The one or more safety mats 60 of FIGS. 6-9 are electrically connected to the one or more controllers 39 (FIG. 2) such that when pressure is applied to the one or more safety mats 60, movement of the main frame 45 is halted or prevented to avoid unwanted lowering or raising until the pressure is removed. Preferably, certified safety mats 60 are positioned at each moving edge of the platform that is not otherwise obstructed (e.g., by guard panels 55).

Although described with reference to preferred embodiments, it should be readily understood that various changes or modifications could be made to the invention without departing from the spirit thereof. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description. In general, the invention is only intended to be limited by the scope of the following claims.

1. An operator platform comprising:
a floor plate;
a low-profile frame positioned beneath the floor plate and including a first plurality of struts arranged to establish a perimeter of the low-profile frame and a second plurality of struts arranged to establish a strut pattern that is interior to the perimeter of the low-profile frame and strengthens the low-profile frame, wherein the perimeter of the low-profile frame has an exterior surface; and
a first kick plate attached to the exterior surface of the perimeter of the low-profile frame and extending above the floor plate to support the frame.

2. The operator platform of claim 1, wherein the first kick plate extends along at least a majority of the length of one of the first plurality of struts.

3. The operator platform of claim 1, further comprising a second kick plate attached to the exterior surface of the perimeter of the low-profile frame and extending above and perpendicular to the floor plate.

4. The operator platform of claim 3, wherein the first kick plate and the second kick plate are attached to different struts of the first plurality of struts.

5. The operator platform of claim 4, wherein the first kick plate is parallel to the second kick plate.

6. The operator platform of claim 4, wherein the first and second kick plates each extend along at least a majority of the length of their respective strut of the first plurality of struts.

7. The operator platform of claim 1, wherein the pattern established by the second plurality of struts includes one or more triangle shapes defined by the second plurality of struts.

8. The operator platform of claim 1, further comprising one or more linear actuator systems attached to the exterior surface of the perimeter of the low-profile frame.

9. The operator platform of claim 8, wherein the first kick plate is secured to the low-profile frame, and the one or more linear actuator systems is configured to lower the floorplate to about two inches above a support surface.

10. An operator platform comprising:
a low-profile frame including a first plurality of struts arranged to establish a perimeter of the low-profile frame and a second plurality of struts arranged to establish a strut pattern that is interior to the perimeter of the low-profile frame, wherein the perimeter of the low-profile frame has an exterior surface;
a first kick plate attached to the exterior surface of the perimeter of the low-profile frame and extending above the low-profile frame; and
a linear actuator system attached to the exterior surface of the perimeter of the low-profile frame.

11. The operator platform of claim 10, wherein the first kick plate extends along at least a majority of the length of one of the first plurality of struts.

12. The operator platform of claim 10, further comprising a second kick plate attached to the exterior surface of the perimeter of the low-profile frame and extending above the low-profile frame.

13. The operator platform of claim 12, wherein the first kick plate and the second kick plate are attached to different struts of the first plurality of struts.

14. The operator platform of claim 13, wherein the first kick plate is parallel to the second kick plate.

15. The operator platform of claim 13, wherein the first and second kick plates each extend along at least a majority of the length of their respective strut of the first plurality of struts.

16. The operator platform of claim 10, wherein the linear actuator system is configured to lower a top of the low-profile frame to about two inches above a support surface.

17. The operator platform of claim 10, wherein the pattern established by the second plurality of struts includes one or more triangle shapes defined by the second plurality of struts.

18. The operator platform of claim 10, wherein the first kick plate being attached to the frame and the strut pattern established by the second plurality of struts strengthen the frame.
